(19) United States
(12) Patent Application Publication
(10) Pub. No.: US 2001/0004792 A1
(43) Pub. Date: Jun. 28, 2001

(54) Manufacture process of coupling handle for coupling the drilling rod in the mandrel of blast furnace taphole drill

(76) Inventors: Jose de Sousa Carvalho, Ipatinga (BR); Dario Sanches Manha, Sao Paulo (BR)

Correspondence Address: Martin P. Hoffman, Esq., HOFFMAN, WASSON & GITLER, PC, Suite 522, 2361 Jefferson Davis Highway, Arlington, VA, 22202, US

(21) Appl. No.: 09/739,869

(22) Filed: Dec. 20, 2000

(30) Foreign Application Priority Data
Dec. 23, 1999 (BR) PI9906115-5

(51) Int. Cl. B23P 17/00

(52) U.S. Cl. 29/412

(57) ABSTRACT

The invention proposes a manufacturing process of handle (6) for coupling the drilling rod (5) in the mandrel (3) of the drilling machine (2). Said process contemplates the handle (6) manufacture by means of a forming process of tubes (10) and (12) with inside diameters (Di) and cross sections compatible with both the cross section and outside diameter of the drilling rod (5); the tubes are subsequently cut in sections (Cn) and (An), thus producing the locking cleat (7) and the extended ring (9), respectively, which are then joined by means of welding so as to form the handle (6).

The handles (6) produced by the invented process provide additional advantages in terms of manufacturing time and cost reductions. In the application stage, the handle, as a component of the blast furnace taphole drilling assembly, provides greater operating reliability and stability.

The present invention refers to a manufacture process of a self-aligning handle for quick coupling and uncoupling of the drilling rod in the mandrel of pneumatic or hydraulic drill for opening the blast furnace taphole.

Blast Furnaces are facilities for the production of molten iron to be subsequently processed into steel through the reduction of carbon and other impurities.

The blast furnace is a closed reactor consisting of four different regions, namely the stack, belly, bosh and hearth, as seen vertically in a descending sequence.

The solid fuel and raw materials charging is made through the top, in the stack region, where a burden distribution system transfers the charged material by gravity to the belly region where the reduction process starts. As the charge melts it flows down the bosh and accumulates in the lower part of the reactor, i.e. in the hearth.

The blast furnace discharging process is an intermittent procedure called heat. For each heat the hearth drain is opened so that the molten charge consisting of pig iron and slag is tapped off.

The drain opening operation for tapping the molten charge contained in the hearth is conventionally carried out by means of a drilling device fitted at the end of a metallic rod, which is coupled to a drilling machine.

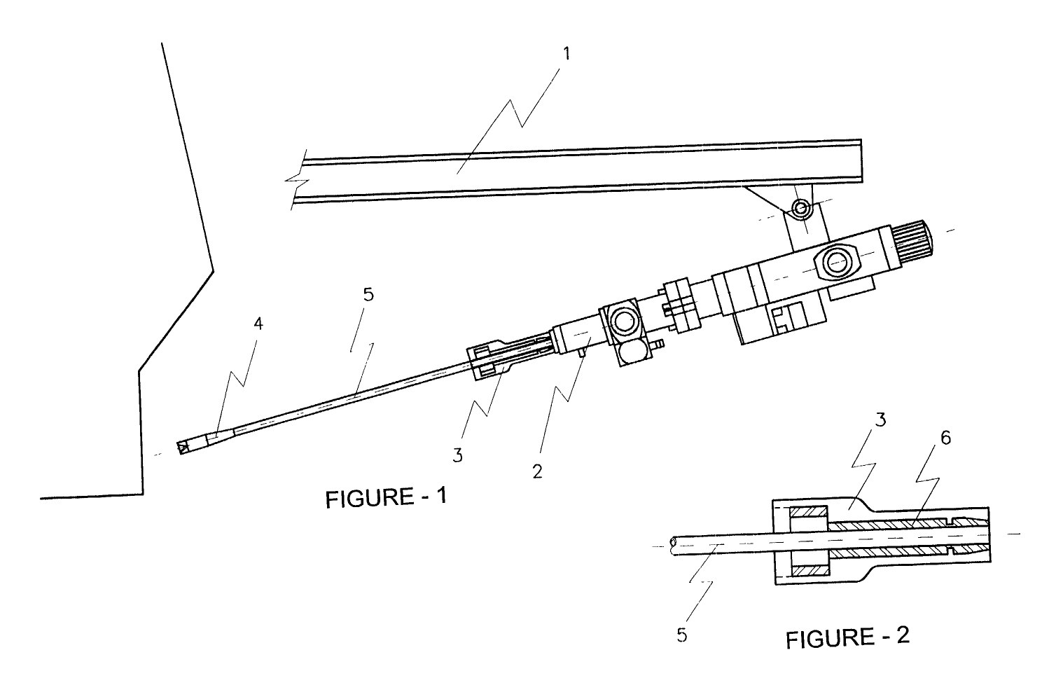

FIGS. 1 and 2 attached schematically represent the drilling assembly used in the taphole opening operation. FIG. 1 shows the side view of the drilling assembly and FIG. 2 shows the details of drilling element coupling into the hydraulic equipment. The numbered items in these figures mean:

1. supporting structure;

2. drilling machine;

3. mandrel;

4. drilling element;

5. drilling rod;

6. coupling handle.

The supporting structure (1) supports the drilling machine (2), so as to allow it to be properly positioned for the blast furnace tapping operation. Such drilling machine (2) is fitted with a mandrel (3) for coupling the drilling rod (5) with the help of a handle (6). The rod (5) end is fitted with a drilling element (4), which is actuated by the drilling machine (2), thus actually opening the taphole for tapping off the blast furnace molten charge. As shown in detail in FIG. 2, the handle (6) is fitted at the end of the drilling rod (5) and coupled to the mandrel (3) of the drilling machine (2). Such coupling is one of the critical operational points, being the handle (6) the component appointed as responsible for some negative factors related to time, safety and costs of the preparation stage of the blast furnace taphole drilling assembly.

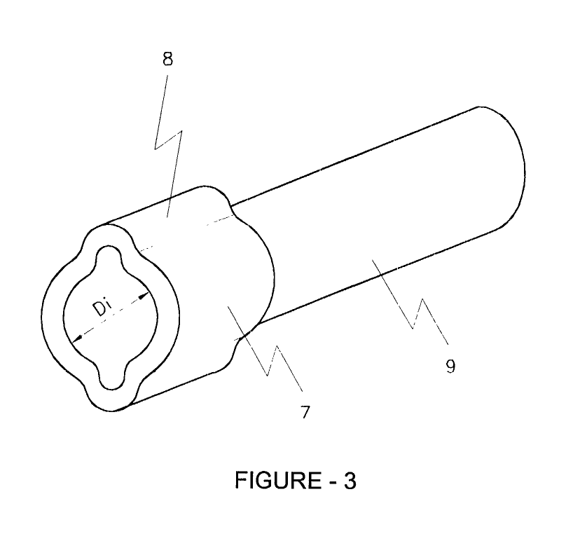

FIG. 3 attached is a perspective view of the handle (6) showing:

7. locking cleat;

8. lug;

9. extended sealing ring.

Such handle (6) is usually manufactured by a casting process and subsequent machining, thus generating a relatively high final production cost for a component intended to be used only once, being then disposed of after each blast furnace tapping operation. Another negative factor inherent to the conventional manufacturing process is the presence of critical wearing areas and low mechanical strength points in the handles (6). Lug (8) wear or even rupture is a frequent occurrence, thus affecting the tapping operation, since without an efficient working condition of such lug (8) it is impossible to remove the rod (5) by just moving the drilling machine (2) backwards. Under this circumstance, the rod (5) must be manually removed, which exposes the operator to excessive heat and accident risk.

Moreover, the conventionally manufactured handles (6) present alignment difficulties during its assembling and fastening in the drilling rod (5). Under such condition the rod (5) may buckle or even break due to the impact of the drilling machine (2) hammer when the assembly is projected against the blast furnace taphole stopper. Such occurrence results in the interruption of the tapping operation for replacing the damaged drilling rod (5), which is inevitably disposed of, thus generating additional costs and time expenditure.

The “MANUFACTURE PROCESS OF COUPLING HANDLE FOR COUPLING THE DRILLING ROD IN THE MANDREL OF BLAST FURNACE TAPHOLE DRILL” as proposed in the invention privilege claim, contemplates the handle manufacture by a forming process in which two different tubes with characteristic shapes are processed for the subsequent production of the handles (6).

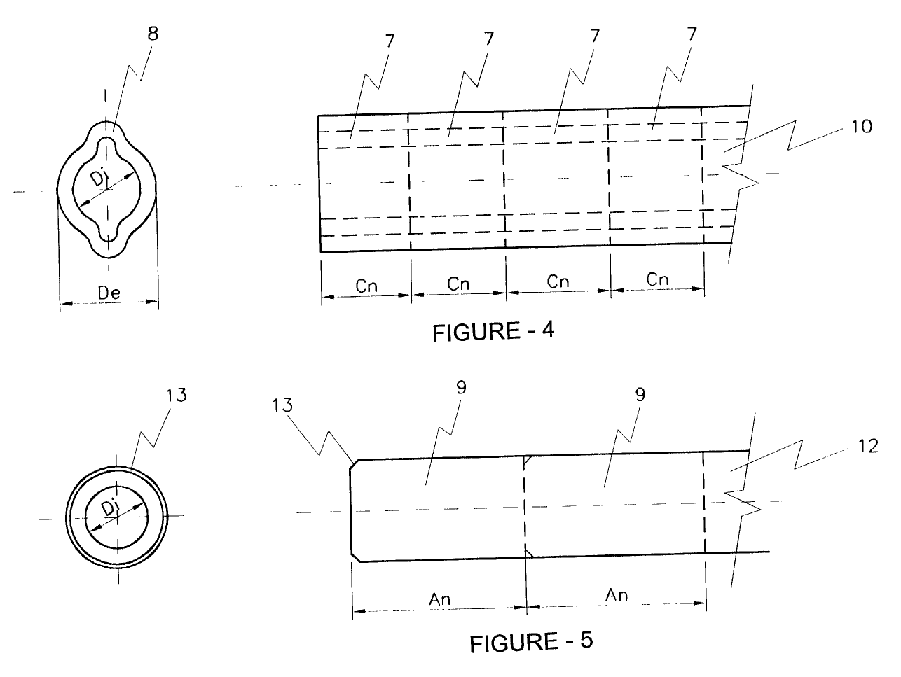

FIGS. 4 and 5 attached show said tubes with the following details:

7. locking cleat;

8. lug;

9. extended ring;

10. ribbed tube;

11. ribbing;

12. smooth tube;

13. bevel;

De. outside diameter;

Di. inside diameter;

Cn. ribbed tube cross section;

Ca. smooth tube cross section;

The first stage of the process proposed by the invention refers to the forming of the ribbed tube (10) with inside diameter (Di) compatible with the outside diameter of the drilling rod (5) and suitable outside diameter (De) defined as a function of the available space for coupling the handle (6) into the mandrel (3) of the drilling machine (2). The external profile of said tube (10) is provided with ribs (11), which shall become the lugs (8) of the handle's (6) locking cleat (7). After the forming to the already described profile and dimensions, the ribbed tube (10) is cut in sections (Cn), thus producing the locking castanhas (7).

The second process stage of this invention refers to the forming of the smooth tube (12), which inside diameter (Di) is equal to the inside diameter (Di) of the ribbed tube (10), being therefore also compatible with the fitting to the outside diameter of the drilling rod (5). As far the outside diameter (De) of said tube (12) is concerned, it is defined as a function of the available space for coupling the handle (6) into the mandrel (3) of the drilling machine (2).

After formed and cut in sections (An), the smooth tube (12) is subjected to machining in one of its ends, thus producing the bevel (13) for the weld fillet deposition in order to join the tube to the locking cleat (7). The opposite end of the tube (12) is provided with a tapered undercut (14) obtained by machining, intended to offset eventual mechanical deformations of the handle (6) caused by the impact of the drilling machine's (2) hammer. Such arrangement allows avoiding the jamming of the handle (6) inside the mandrel (3) when it is decoupled from the drilling rod (5) upon the end of the blast furnace taphole opening operation.

For the sake of description simplicity, the process hereby described mentions just handles (6) designed to be fastened in drilling rods (5) with cylindrical cross section. However, the invention scope includes also the utilization of this process for manufacturing handles to be fastened in drilling rods with other cross-sectional profiles, in which case it is just a question of adapting the diameter profile (Di) of the tubes (10) and (12) to the drilling rod's cross-sectional profile.

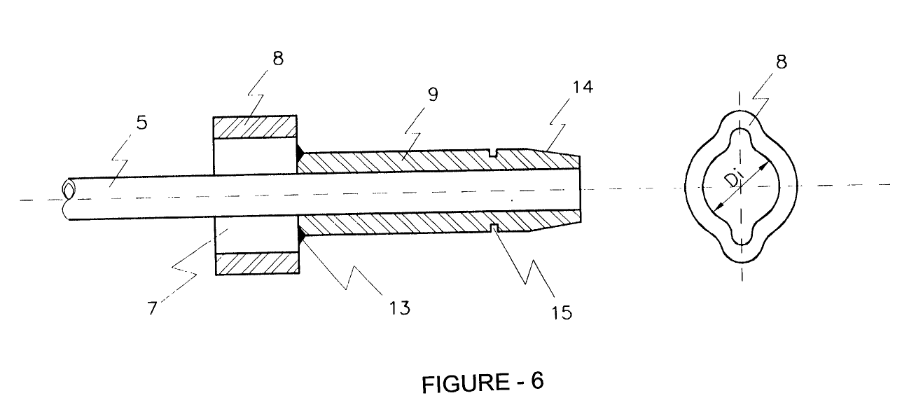

FIG. 6 attached shows the final appearance of the handle (6) and its fastening to the drilling rod (5) both in front elevation and cross section, including:

5. drilling rod;

7. locking cleat;

8. lug;

9. extended ring;

13. bevel;

14. tapered undercut;

15. groove;

Di. handle inside diameter.

As shown in FIG. 6, the locking cleat (7) and the extended ring (9) are fitted to the end of the drilling rod (5), being joined by a weld fillet circularly deposited on the bevel (13) of the extended ring (9), thus producing the handle (6). The alignment of said handle (6) with the drilling rod (5) results from the accurate matching of the outside diameter of the drilling rod (5) with the inside diameter of the handle (6).

As a result of the own forming manufacture process characteristics, the lugs (8) of the locking cleat (7) show a higher mechanical strength, thus eliminating the possibility of rupture or excessive wear during the operation.

The tapered undercut (14) provides a slight reduction in the outside diameter of the extended ring (9) end in order to offset eventual deformations in this point caused by the hammer impact, thus preventing a possible jamming of the handle (6) in the mandrel (3) of the drilling machine (2) upon its decoupling. Moreover, the extended ring (9) is provided with a circular groove (15) close to the tapered undercut (14) to eventually house a sealing ring, which can be optionally used to optimize the cooling fluid sealing.

The handle (6) produced in accordance with the invented process has a manufacturing cost compatible with its one-way application feature, besides assuring a good operating performance due to its self-aligning characteristic upon fastening in the drilling rod (5).

Taking the above into consideration, it is evident that the handles (6) produced with the invented process provide additional advantages in terms of manufacturing time and costs. In the application stage, as a component of the blast furnace taphole drilling assembly, the handle provides greater operating reliability and stability.

1. “MANUFACTURE PROCESS OF COUPLING HANDLE FOR COUPLING THE DRILLING ROD IN THE MANDREL OF BLAST FURNACE TAPHOLE DRILL” for producing handles (6) by tube forming process characterized by the forming of ribbed tubes (1) and smooth tubes (12) with inside diameter (Di) and cross section profile compatible respectively with the outside diameter and the cross section profile of the drilling rod (5). Such tubes (10) and (12) are subsequently cut in sections (Cn) and (An), thus producing the locking cleat (7) and the extended ring (9), respectively, which are joined by means of a weld fillet circularly deposited on the bevel (13) of said extended ring (9), thus forming the handle (6) for coupling the drilling rod (5) to the mandrel (3) of the drilling machine (2).

2. “MANUFACTURE PROCESS OF COUPLING HANDLE FOR COUPLING THE DRILLING ROD IN THE MANDREL OF Blast furnace taphole drill” in accordance with claim 1, characterized by the tube (10) for the manufacture of the locking cleat (7), and by the ribbing (11) that shall become the lugs (8) for locking the handle (6) into the mandrel (3).
